(19) United States
(12) Patent Application Publication
(10) Pub. No.: US 2024/0344496 A1
(43) Pub. Date: Oct. 17, 2024

(54) AERODYNAMIC CONTROL DEVICES FOR DUCTED FLUID TURBINES

(71) Applicant: Vincent Loccisano, Wellesley, MA (US)

(72) Inventor: Vincent Loccisano, Wellesley, MA (US)

(21) Appl. No.: 18/633,614

(22) Filed: Apr. 12, 2024

Related U.S. Application Data
(60) Provisional application No. 63/495,742, filed on Apr. 12, 2023.

(51) Int. Cl. F03D 1/06

(52) U.S. Cl. CPC F03D 1/0675; F05B 2240/30

(57) ABSTRACT

A “strake” is a device intended to mitigate oscillations in vortex shedding over a bluff body. In a ducted turbine, wind flowing perpendicular to the central axis of the duct can propagate oscillating vortex shedding. Such oscillations can result in resonant vibrations and cause stress or damage to the turbine and support structure. A strake is a protrusion extending upward with respect to, or perpendicular to, the outer surface of the duct that causes separation of flow over the surface and prevents oscillating vortex shedding.

### BACKGROUND

Conventional horizontal axis wind turbines (HAWTs) used for power generation have two to five open blades arranged like a propeller, the blades being mounted to a horizontal shaft attached to a gear box which drives a power generator. HAWTs often comprise blades with pitch control for the purpose of furling the blades into the wind to mitigate speed and torque on the generator. Blade-pitch control provides a means of regulating the power output of an individual or group of turbines, and to protect the turbine and electrical generation equipment from damage caused by excessive fluid-velocity events. Excessive fluid-velocity events can cause various types of asymmetrical loading on the tower and rotor plane. Asymmetrical loading can cause oscillations that cause stress to the tower and can effect electrical generation equipment. By furling the blades of a HAWT into the wind in the highly-loaded regions of the rotor plane and out of the wind in the lesser-loaded regions of the rotor plane, oscillations can be mitigated. Similarly, in high fluid-velocity events, blades can be furled to avoid excessive thrust force on the tower.

One skilled in the art will understand that a properly designed duct, delivers greater mass flow rate to the interior of the duct than to the exterior. Improved performance over that of a similar open rotor, from a rotor in fluid communication with a properly designed duct, may be achieved due to a reduction of rotor-tip vortices and the increased unit mass flow through the duct.

The present disclosure relates to a fluid turbine providing power extraction improvements to an open rotor comprising at least one duct in fluid communication with a rotor plane, more specifically to a fluid turbine duct comprising aerodynamic control devices and a method for mitigating oscillations caused by vortex shedding over the duct, during excessive fluid-velocity events.

The term “Kármán vortex street” is used in fluid dynamics to describe a repeating pattern of swirling vortices caused by the unsteady separation of flow of a fluid over bluff bodies. Eddies are shed continuously from each side of the body, forming rows of vortices in the wake. Alternate shedding of vortices results in periodic, lateral forces on the body, causing it to vibrate. If the frequency of the vortex shedding is similar to the natural frequency of the body it results in resonance that can cause damage to the body and/or support structure.

Strakes are devices intended to discourage the alternate shedding of vortices. A strake is at least one projection, extending upward with respect to, or perpendicular to, the exterior surface of the duct. Strakes cause separation of the boundary layer over a bluff body at a specific point and cause the vortex shedding to occur without oscillations, thus preventing undesirable vibration and stress to the duct and support structure. As used herein, reference to “support structure” or “tower” is intended to include all structure used in orientating and supporting the turbine assembly.

The acrodynamic principles of a ducted turbine are not restricted to air and apply to any fluid, defined as any liquid, gas or combination thereof and therefore including water as well as air. In other words, the aerodynamic principles of a ducted turbine apply to hydrodynamic principles in a ducted water turbine. For the purpose of convenience, the present embodiment is described in relation to ducted wind turbine application. Such a description is solely for convenience and clarity and is not intended to be limiting in scope.

### SUMMARY

The present disclosure relates to the use of strakes on a ducted turbine to provide a means for controlling vortex shedding, specifically, in high wind conditions when the wind flows perpendicular to the turbine central axis.

An example embodiment comprises a ducted turbine. A substantially annular duct that is in fluid communication with a rotor is referred to as a turbine shroud. The turbine shroud comprises protrusions that extend from the outer surface, proximal to the top and bottom of the duct, outward from the central axis. Such protrusions are referred to as “strakes.”

Another embodiment comprises a turbine shroud formed with mixing elements. The leading edge of the turbine shroud is substantially cylindrical with a leading-edge airfoil cross section. Some embodiments include mixing elements that are inward and outward turning airfoil cross sections. In some embodiments the trailing edge of the turbine shroud is in fluid communication with a ringed airfoil, referred to as an ejector shroud. The turbine and ejector shroud are generally co-axial, or in other words, share a central axis that resides along the center of the cylindrical-airfoil shapes.

Both turbine shroud and ejector shroud may comprise strakes on the exterior surface of the shrouds and provide a means of controlling vortex shedding and preventing oscillations particularly in excessive wind conditions with wind flowing perpendicular to the turbine central axis.

A shrouded wind turbine has been described in U.S. patent application Ser. No. 12/054,050. It would be desirable to provide a structure that provides a means of controlling vortex shedding for the purpose of mitigating stress on the tower caused by oscillations in excessive wind conditions.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a diagram depicting vortex shedding over a cylinder.

FIG. 2 is a diagram depicting vortex shedding over a cylinder comprising at least two strakes.

FIG. 3 is a front perspective view of an example embodiment of the present disclosure.

FIG. 4 is a side, orthographic, detailed, section view of the fluid turbine of FIG. 3.

FIG. 5 is a front, orthographic view of a ducted fluid turbine without strakes, depicting vortex shedding over the duct.

FIG. 6 is a front, orthographic view of the fluid turbine of FIG. 3 depicting vortex shedding over the duct comprising strakes.

FIG. 7 is a front right perspective view of an iteration of the embodiment including a turbine shroud with mixing elements and an ejector shroud.

FIG. 8 is a side, detail, cross-section view of the embodiment of FIG. 7 with strakes engaged with turbine and ejector shrouds.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

A properly designed ducted rotor, delivers greater mass flow rate to the interior of the duct than to the exterior. Improved performance over that of a similar open rotor, from a rotor in fluid communication with a properly designed duct, may be achieved due to a reduction of rotor-tip vortices and the increased unit mass-flow through the duct.

A Mixer-Ejector Turbine provides an improved means of generating power from fluid currents. The Mixer-Ejector Turbine includes tandem cambered shrouds and a mixer/ejector pump. The primary shroud contains a rotor, which extracts power from a primary fluid stream. The tandem cambered shrouds and ejector bring more flow through the rotor allowing more energy extraction due to higher flow rates. The mixer/ejector pump transfers energy from the bypass flow to the rotor wake flow allowing higher energy per unit mass flow rate through the rotor. These two effects enhance the overall power production of the wind turbine system.

The term “rotor” is used herein to refer to any assembly in which one or more blades are attached to a shaft and able to rotate, allowing for the extraction of power or energy from wind rotating the blades. Exemplary rotors include a propeller-like rotor or a rotor/stator assembly. Any type of rotor may be enclosed within the turbine shroud in the wind turbine of the present disclosure.

The leading edge of a turbine shroud may be considered the front of the wind turbine, and the trailing edge of an ejector shroud may be considered the rear of the wind turbine. A first component of the wind turbine located closer to the front of the turbine may be considered “upstream” of a second component located closer to the rear of the turbine. Put another way, the second component is “downstream” of the first component.

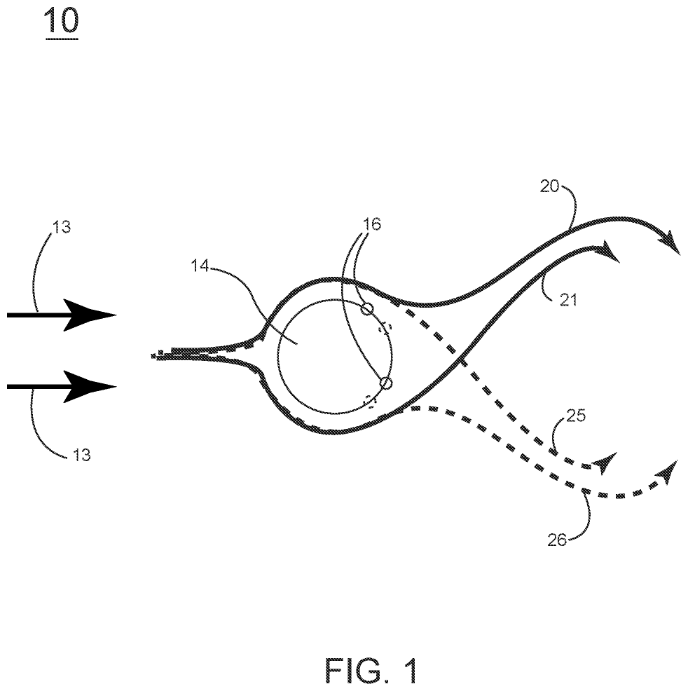

FIG. 1 is a diagram depicting unsteady flow over a cylinder. A fluid stream flowing in a direction represented by arrows 13 encounters a cylinder 14 and is diverted into two fluid streams that separate from the cylinder and form two sets of vortices. One set of vortices is depicted by arrow 20 and arrow 21 and separates from the cylinder at points 16. A second set of vortices is represented by dotted arrow 25 and dotted arrow 26 and separates from the cylinder 14 at points 18. Flow over a cylinder will tend to oscillate between the pair of vortices 20/21 and the opposing pair 25/26.

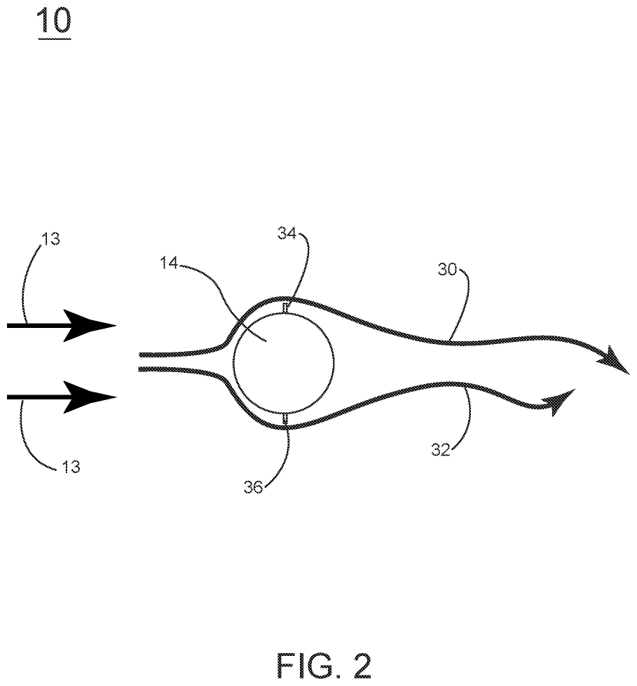

FIG. 2 is a diagram depicting the steady flow over a cylinder comprising strakes. A fluid stream flowing in a direction represented by arrows 13 encounters a cylinder 14 and is diverted into two fluid streams, fluid stream 30 on the left-side of the cylinder 14 that separates from the cylinder 14 at strake 34; and fluid stream 32 on the right-side of the cylinder 14 that separates at strake 36 and forms a set of vortices that mix without oscillation along fluid paths 30/34.

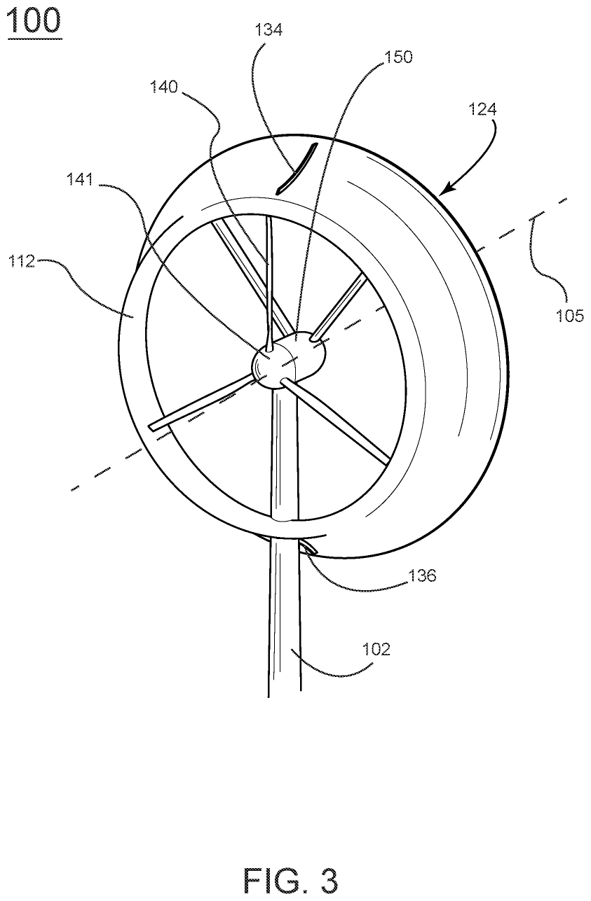

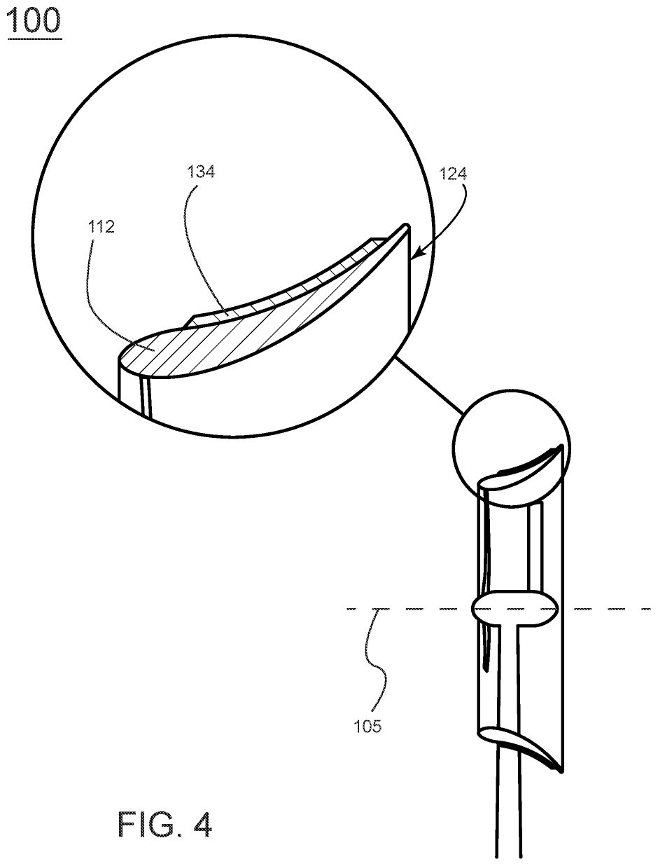

FIG. 3 is a perspective view of an exemplary embodiment of a shrouded fluid turbine of the present disclosure. FIG. 4 is a detail, side, cross-section view of the turbine of FIG. 3. The shrouded fluid turbine 100 comprises a turbine shroud 110, a nacelle body 150 and a rotor 140. The turbine shroud 110 includes a front end 112, also known as an inlet end or a leading edge and a rear end 124, also known as an exhaust end or trailing edge. The rotor 140, nacelle 150, and shroud 110 are coaxial, sharing a common axis 105. At least one set of strakes including an upper strake 134 and lower strake 136 are engaged with or derived from at least one portion of the outer surface of the turbine shroud 110.

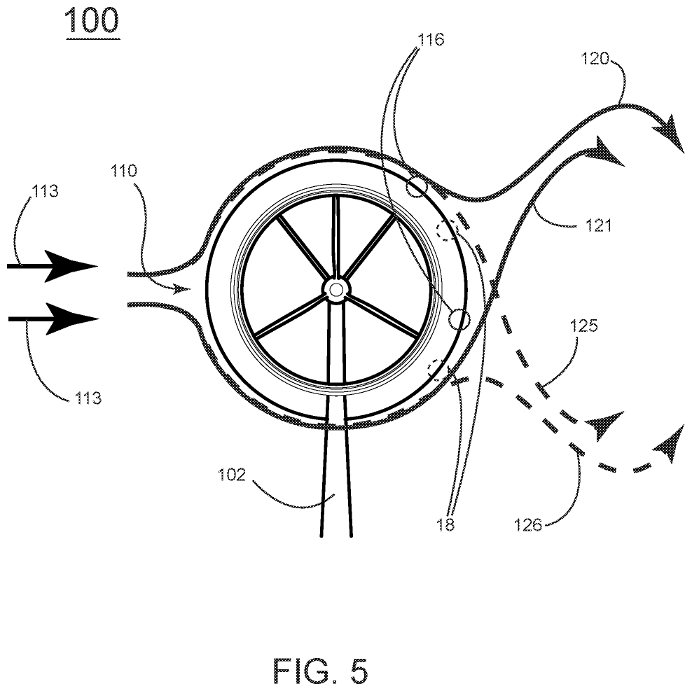

FIG. 5 depicts unsteady flow over a ducted turbine. A fluid stream flowing perpendicular to the turbine central axis, in a direction represented by arrows 113 encounters a the turbine shroud 110 and is diverted into two fluid streams that separate from the turbine shroud and form two sets of vortices. One set of vortices is depicted by arrow 120 and arrow 121 and separates from the cylinder at points 116. A second set of vortices is represented by dotted arrow 125 and dotted arrow 126 and separates from the turbine shroud 110 at points 118. Flow over a turbine shroud 110 will tend to oscillate between the pair of vortices 120/121 and the opposing pair 125/126, causing vibration and stress on the tower 102.

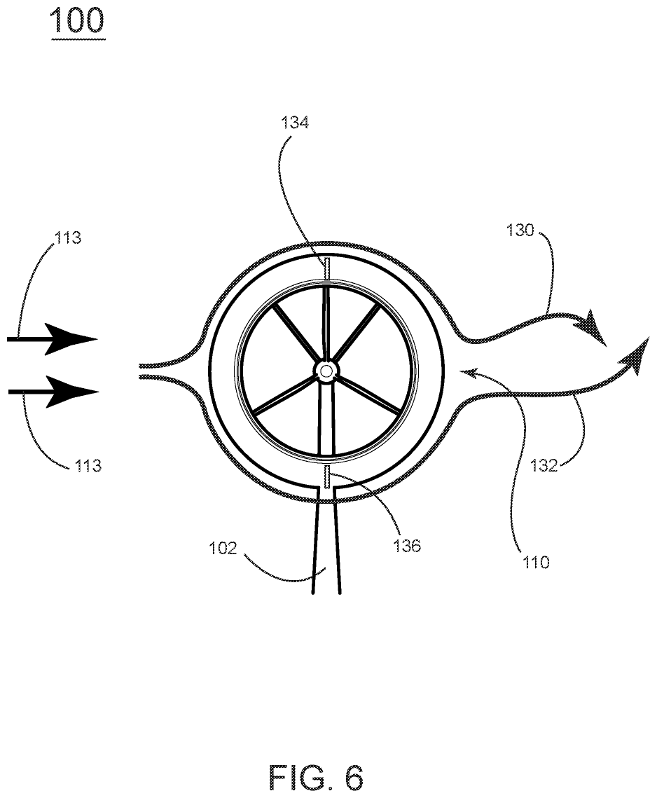

FIG. 6 depicts the steady flow over a ducted turbine comprising strakes. A fluid stream flowing perpendicular to the turbine central axis, in a direction represented by arrows 113 encounters a turbine shroud 110 and is diverted into two fluid streams, fluid stream 130 flowing over the top of the turbine shroud 110 that separates from the turbine shroud at strake 134 and fluid stream 132 proximal to the lower portion of the turbine shroud, that separates at strake 136 and forms a set of vortices that mix without oscillation along fluid paths 130/134.

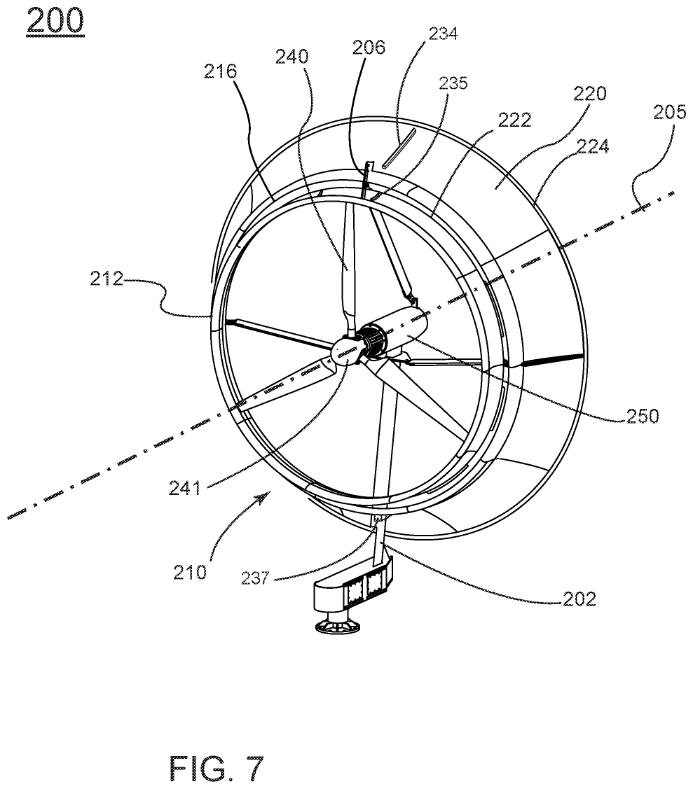

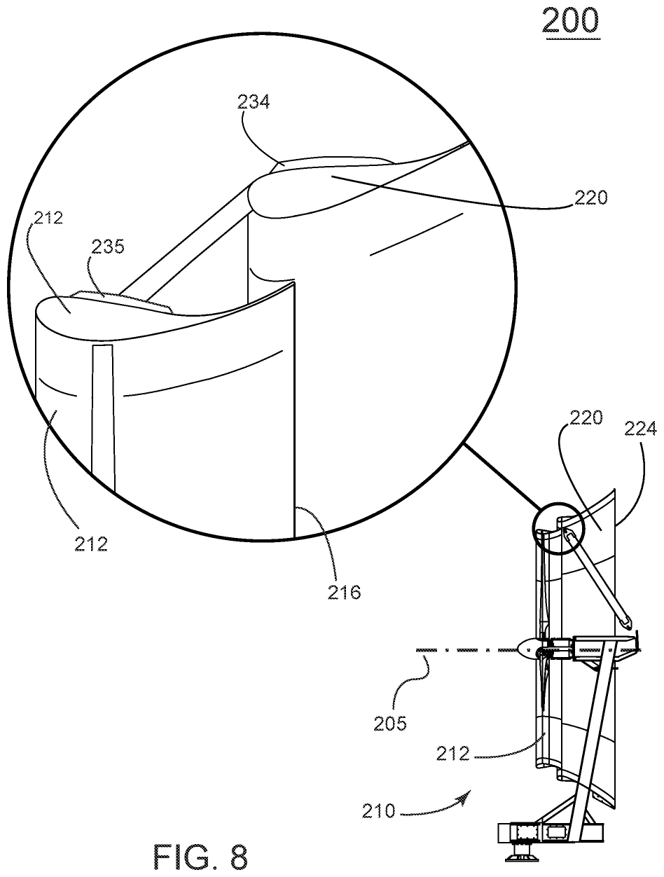

FIG. 7 and FIG. 8 are a front perspective view, and detail, side, cross-section view respectively, of an additional embodiment of a shrouded fluid turbine of the present disclosure. Referring to FIG. 7 and FIG. 8, the shrouded fluid turbine 200 comprises a turbine shroud 210, a nacelle body 250, a rotor 240, and an ejector shroud 220. The turbine shroud 210 includes a front end 212, also known as an inlet end or a leading edge. The turbine shroud 210 also includes a rear end 216, also known as an exhaust end or trailing edge. The ejector shroud 220 includes a front end, inlet end or leading edge 222, and an exhaust end, or trailing edge 224. The rotor 240 surrounds the nacelle body 250 and comprises a central hub 241 at the proximal end of the rotor blades. The central hub 241 is rotationally engaged with the nacelle body 250. The nacelle body 250 and the turbine shroud 210 are supported by a tower 202. The rotor 240, turbine shroud 210, and ejector shroud 220 are coaxial with each other, i.e. they share a common central axis 205. A generator is disposed within the nacelle 250 and is engaged with the rotor by an energy transfer means such as a direct drive, a belt drive or through a transmission.

The turbine shroud has the cross-sectional shape of an airfoil with the suction side (i.e. low-pressure side) on the interior of the shroud. The rear end 216 of the turbine shroud also has mixing elements including outward directed mixing elements 215 and inwardly directed mixing elements 217. The mixing elements extend downstream beyond the rotor blades and are directed either outward or inward with respect to the central axis 205. Put another way, the trailing edge 216 of the turbine shroud is shaped to form two different sets of mixing elements. Inwardly directed mixing elements 217 extend inward, towards the central axis 205 of the mixer shroud. Outwardly directed mixing elements 215 extend outward, away from the central axis 205.

At least one set of strakes are engaged with the ejector shroud 220 and/or turbine shroud 210. Strakes may include but are not limited to an upper ejector strake 235 proximal to the upper portion of the ejector shroud 220, lower ejector strake 236 proximal to the lower portion of the ejector shroud 220, an upper turbine strake 235 proximal to the upper portion of the turbine shroud and a lower turbine strake 237 proximal to the lower portion of the turbine shroud.

One skilled in the art will understand that strakes may be located at various locations about the circumference of the aforementioned ringed airfoils depending on specific design and environmental factors.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1) A fluid turbine, comprising:
a rotor in communication with a generator;
a duct in fluid communication with said rotor;
at least two protrusions, extending perpendicular to the outer surface of the duct; wherein
said at least two protrusions mitigate oscillations in vortex shedding over the surface of the duct.

2. The fluid turbine of claim 1, wherein the at least two protrusions reside in a retracted state in the surface of the duct and are deployed in high winds.

3. The fluid turbine of claim 1 further comprising:
said duct having an upper portion, a lower portion and two side portions; and
said at least two protrusions are arrayed about the exterior of said duct proximal to said upper portion and said lower portion.

4. The fluid turbine of claim 1 further comprising:
said duct having a leading edge and a trailing edge and a chord length between said leading edge and said trailing edge; and
said at least two protrusions having a length that is between 25% and 75% of said chord length.

5. The fluid turbine of claim 4 further comprising:
said at least two protrusions having a depth that is between 0.5% and 1% of said chord length.
